(19) United States
(12) Patent Application Publication
(10) Pub. No.: US 2011/0077164 A1
(43) Pub. Date: Mar. 31, 2011

(54) EXPRESSION PROFILING PLATFORM TECHNOLOGY

(76) Inventors: Andras GUTTMAN, San Diego, CA (US); Laszlo Takacs, Newbury Park, CA (US)

(21) Appl. No.: 12/889,935

(22) Filed: Sep. 24, 2010

Related U.S. Application Data
(63) Continuation-in-part of application No. 11/665,539, filed on Apr. 17, 2007, now abandoned.
(60) Provisional application No. 60/621,423, filed on Oct. 23, 2004.

(51) Int. Cl. C40B 30/04; C40B 50/06; C40B 30/00

(52) U.S. Cl. 506/9; 506/26; 506/7

(57) ABSTRACT

The present invention relates to an efficient mAb panel-based expression profiling technology platform suitable for global and accurate measurement of proteins, peptides and metabolites in complex mixtures. The platform is comprised of new and well established technologies that are coupled in a unique fashion to provide a novel platform technology for (i) the discovery of differentially displayed elements of complex protein, peptide and metabolite mixtures and (ii) the development of robust mAb based assays that detect the differentially expressed elements.

The present application is a continuation-in-part of U.S. application Ser. No. 11/665,539 (pending), which was filed Apr. 17, 2007 (published as US 2007-0293437 A1 on Dec. 20, 2007), which is a U.S. national phase of International Application No. PCT/IB2005/003397, filed Oct. 21, 2005, which designated the U.S. and claims priority to U.S. Provisional Application No. 60/621,423, filed Oct. 23, 2004, the entire contents of each of which are hereby incorporated by reference.

### INTRODUCTION

The present invention relates to an efficient mAb-based expression profiling technology platform suitable for global and accurate measurement of proteins, peptides and metabolites in complex mixtures. The invention also relates to methods for identifying or isolating biomarkers as well as to methods for preparing antibodies.

### BACKGROUND

Small molecule metabolite, peptide and protein expression analysis is a growing field in the medicinal, veterinarian, food and environmental monitoring and profiling areas. In particular, global proteome profiling with affinity reagents is an evolving field. One of the most useful affinity reagents is the monoclonal antibody, which if applied onto microarrays or to other highly multiplex systems allows simultaneous detection of multiple analytes in one experiment. The expectation and the requirement is that a global profiling tool should cover the entire cognate ligand (e.g., antigenic) space.

WO2005/077106 relates to a method of identifying biomarkers specific to a disease condition. However, it does not describe the process of specific immunization strategies, analyte library, antibody production, methods of producing monoclonal antibody panels suitable to monitor expression of metabolites and peptides, or the application of these to develop monoclonal antibody arrays. Furthermore, it does not disclose a global approach to the generation of antibody libraries. Precise profiling with the method described herein provides an easy tool for the identification of relevant antigens as well as differences.

Moreover, as parallel with the expression analysis and antigen ID, specific mAbs become available; simple or complex antibody based assays are designed for further monitoring and screening only the relevant and differentially expressed elements of the samples. The resulting mAb libraries with their antigen ID could serve as starting panel for the development of simplex or multiplex assays for sensitive, accurate and large scale measurements.

### SUMMARY OF THE INVENTION

The present invention relates to novel expression profiling methods suitable for global and accurate measurement of proteins, peptides and metabolites in complex mixtures. The invention can be used to generate libraries or panels of monoclonal antibodies specific for blood antigens. It may be used to determine the expression of any analyte from a large variety of complex samples, including samples of human, animal, vegetal or environmental origin. The invention is useful to provide markers, targets, diagnostics and tools useful e.g., in medicinal, veterinarian, food and environmental industries.

Following particular immunization and treatment strategies, a large number of mono- or oligoclonal hybridoma supernatants are generated. The entire mAb panel covers the immunogen space of individual protein, peptide or metabolite epitope elements with at least one mAb. Thus, the advanced expression profiling technologies permit the construction of a platform that fulfills three yet unmet needs of protein and metabolite expression analysis: (i) quasi-global coverage, (ii) high level of reproducibility (iii) high sensitivity. Application of cutting edge protein, peptide and metabolite separation technologies for antigen ID completes the technology platform. The high throughput nature and global coverage enable the technology platform to feed into complex data analysis and integration processes.

A first object of this invention relates to a method of global protein, peptide and/or metabolite expression profiling from a complex analyte sample, comprising the following steps:
a) Enrichment of the complex analyte sample;
b) Immunization of a non-human mammalian subject with either (i) the enriched complex analyte sample or an aliquot or dilution thereof (shotgun immunization) or (ii) or with a limited analyte library prepared from the enriched complex analyte sample (Limited Immunization); or (iii) with the analyte that is conjugated to a carrier prior to immunization (Conjugated immunization); and
c) Generation of a panel of monoclonal antibodies, derivatives thereof, corresponding hybridomas and/or producing cells, and optionally, analysing the expression profile of said antibodies and/or identifying any antigen bound by antibodies from the panel.

A further aspect of this invention resides in a method for identifying antigens, comprising the steps of:
a) providing at least one complex analyte sample comprising antigens;
b) using said untreated or treated sample as immunogen to immunize a non-human vertebrate, referred to shotgun immunization, preparing monoclonal antibodies, or derivatives thereof, specific for complex analyte sample antigens, from said immunized non-human mammalian, thereby obtaining a panel;
c) profile gene expression at the proteome level by the library or a portion thereof;
d) antigen ID screening of analyte library elements,
e) affinity enrichment of antigens of interest by means of using monoclonal antibodies or derivatives thereof for highly specific recognition;
f) treating affinity enriched sample to fractionate and identify antigens of interest; and
g) identify antigen(s) of interest.

A further aspect of this invention resides in a method of identifying antigens, comprising the steps of:
a) providing at least one complex analyte sample comprising antigens;
b) using the whole or any part of the analyte library, wherein parts share physicochemical or biological properties, as immunogen to immunize a non-human vertebrate (referred to as limited immunization);
c) preparing monoclonal antibodies, or derivatives thereof, specific for complex analyte sample antigens, from said immunized non-human mammalian, thereby obtaining a panel;
d) profile gene expression at the proteome level by the library or a part thereof;
e) antigen ID screening of analyte library elements
f) affinity enrichment of antigens of interest by means of using monoclonal antibodies or derivatives thereof for highly specific recognition;
g) treating affinity enriched sample to fractionate and identify antigens of interest; and
h) identify antigens of interest

A further aspect of this invention resides in a method of monoclonal antibody mediated expression profiling by the generation of many mono or oligoclonal hybridomas, mono or oligoclonal hybridoma supernatants, monoclonal antibodies, a monoclonal antibody panel from nom human vertebrates immunized as discussed above and screening said monoclonal antibody panel for differential reactivity for at least two different samples of complex analytes in a process that involves the following steps. In a particular embodiment, the method further comprises a step of identifying antigens recognized by antibodies or derivatives thereof within said complex sample and/or analyte library, said identification typically comprising the steps below:
Reacting selected monoclonal antibody with complex analyte or element of analyte library, or with a biological sample
Eluting cognate antigen
Identification of cognate antigen via hyphenated chromatography and/or electric field mediated separation process—mass spectrometry or direct peptide sequencing methods.

The complex analyte sample may be any complex sample of biological, environmental, industrial, etc. origin, such as a mixture of proteins and small molecules, e.g.: biological samples like: plasma, serum, urine, body fluids, cell lysates, tissue extracts of human and animal origin. Environmental samples; such as soil, water, cloud condensate, food processing intermediates and food products. Cosmetics and other healthcare products. Any complex mixture that contains immunogen metabolites and/or immunogen proteins, peptides. The complex sample could be a mix of individual complex analyte samples.

In a particular embodiment of the invention, the sample is conjugated to a carrier prior to immunization. In this respect, a further aspect of this invention lies in a method for producing a panel of monoclonal antibodies, comprising the steps of:
a) providing at least one complex analyte sample comprising antigens;
b) partitioning the whole or any part of the analyte library, where parts share physicochemical or biological properties,
c) binding, preferably covalently, library members to a carrier (e.g., a protein) such as, without limitation, albumin, polylysin, keyhole limplet haemocyanin, etc.,
d) using conjugated analyte library member as an immunogen to immunize a non-human vertebrate, referred to as limited immunization; and
e) preparing monoclonal antibodies, or derivatives thereof, specific for complex analyte sample antigens, from said immunized non-human mammalian, thereby obtaining said monoclonal antibody panel.

In a preferred embodiment, the method further comprises the following steps:
f) profile gene expression at the peptidome or metabolome level by the set of monoclonal antibodies, or derivatives thereof;
g) antigen ID screening of analyte library elements
h) affinity enrichment of antigens of interest by means of using monoclonal antibodies or derivatives thereof for highly specific recognition;
i) treating affinity enriched sample to fractionate and identify elements of interest; and identify elements of interest

A further particular object of this invention also resides in a method for producing a library or panel of monoclonal antibodies, or derivatives thereof, specific for human blood antigens, the method comprising the steps of:
a) providing at least one biological sample comprising human blood antigens;
b) treating said sample under conditions allowing depletion of abundant proteins while retaining low abundant proteins present in normal human blood;
c) using said treated sample or a portion thereof as an immunogen to immunize a non-human mammalian; and
d) preparing monoclonal antibodies, or derivatives thereof, specific for human blood antigens, from said immunized non-human mammalian, thereby obtaining said mAb panel.

The invention also relates to a method of identifying human blood antigens comprising the following steps:

a) providing a sample of human blood and depleting from said sample abundant proteins represented in the plasma at a concentration level higher than 1 mg/ml while retaining low abundant proteins present in normal human blood, said depleted proteins comprising at least one protein selected from the group consisting of human serum albumin, IgG, IgA, transferrin, haptoglobin, and anti-trypsin; wherein the depleted sample comprises less than 5% of total proteins present in normal human blood;
b) immunizing a rodent using as an immunogen the depleted sample of a), or an aliquot or dilution thereof, wherein said immunization comprises from 3 to 6 sequential injections of less than 15 μg of said immunogen each;
c) generating, from said immunized rodent, a panel of hybridomas which produce a panel of monoclonal antibodies that bind antigens of said sample, wherein said antibodies in said panel exhibit less that 5% mimotope sequence redundancy and wherein each of said hybridomas produces at least 20 ng/ml monoclonal antibody;
d) purifying antigens from the blood sample by affinity enrichment using monoclonal antibodies generated in c); and
e) determining the identity of said human blood antigens.

The invention also concerns a method of making antibodies that bind human blood antigens, comprising the following steps:

a) providing a sample of human blood and depleting from said sample abundant proteins represented in the plasma at a concentration level higher than 1 mg/ml while retaining low abundant proteins present in normal human blood, said depleted proteins comprising at least one protein selected from the group consisting of human serum albumin, IgG, IgA, transferrin, haptoglobin, and anti-trypsin; wherein the depleted sample comprises less than 5% of total proteins present in normal human blood;
b) immunizing a rodent using as an immunogen the depleted sample of a), or an aliquot or dilution thereof, wherein said immunization comprises from 3 to 6 sequential injections of less than 15 μg of said immunogen;
c) generating, from said immunized rodent, a panel of hybridomas which produce a panel of monoclonal antibodies that bind antigens of said sample, wherein said antibodies in said panel exhibit less that 5% mimotope sequence redundancy and wherein each of said hybridomas produces at least 20 ng/ml monoclonal antibody;
d) optionally sequencing one, several, or all of said monoclonal antibodies or the coding nucleic acid;
e) optionally producing one, several or all of said antibodies, or derivatives thereof having the same antigen specificity, by recombinant technology; and f) collecting antibodies of step c), d) or e).

The invention also relates to a mAb panel obtainable by such a method, as well as to any uses thereof.

### LEGEND TO THE FIGURES

FIG. 1: (A): Shotgun immunization based protein, peptide and metabolite expression profiling platform; (B): Monoclonal antibodies characterization and selection process.

FIG. 2: SDS PAGE electrophoresis of treated human plasma analyte, 5 μg of complex protein mix was loaded to each well, a 4-20% acrylamide gel was run and stained with silver nitrate.

FIG. 3: Monoclonal antibodies are captured in the ELISA assay by a goat anti Ig-Fc antibody. Captured antibodies are incubated with biotinylated plasma samples. Reaction is developed by peroxidase coupled avidin complexes. Peroxidase reaction is visualized via OPD and the reaction is measured at 492 nm in an ELISA reader. To detect individual proteins a direct ELISA reaction was applied on pure target proteins and on the eluate of the Aglient column.

FIG. 4: Comassie blue stained SDS PAGE gel. Numbers in parenthesis show the sequence coverage obtained by MALSI-TOF MS/MS.

FIG. 5: Assessment of epitope repertoire and analysis of sequence redundancy.

FIG. 6: IgM profile in non-IgG producing hybridomas.

FIG. 7: Affinity measurement of antibodies against cognate epitope peptides.

FIG. 8: Generation of lung cancer biomarkers and antibodies

### DETAILED DESCRIPTION OF THE INVENTION

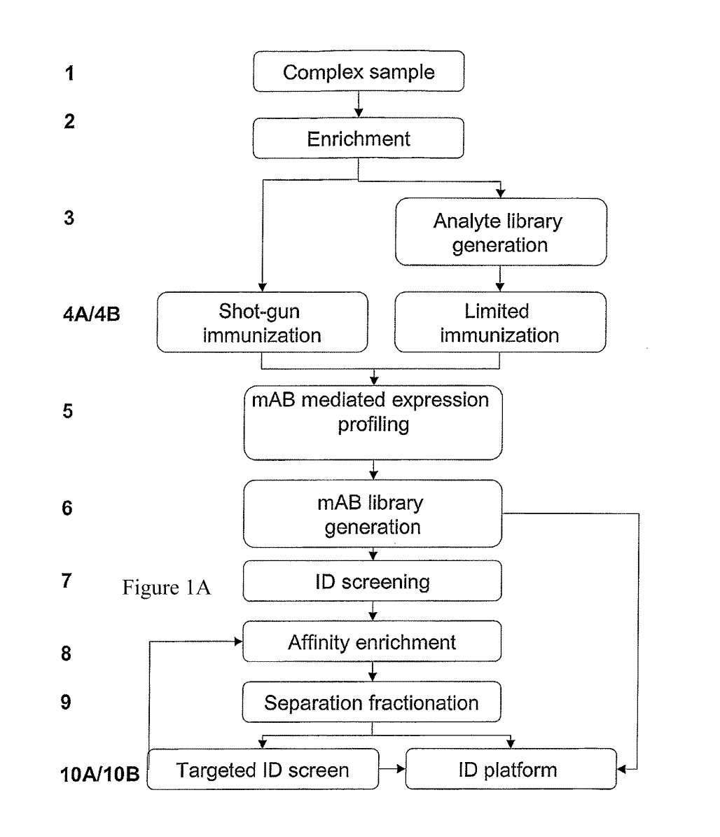

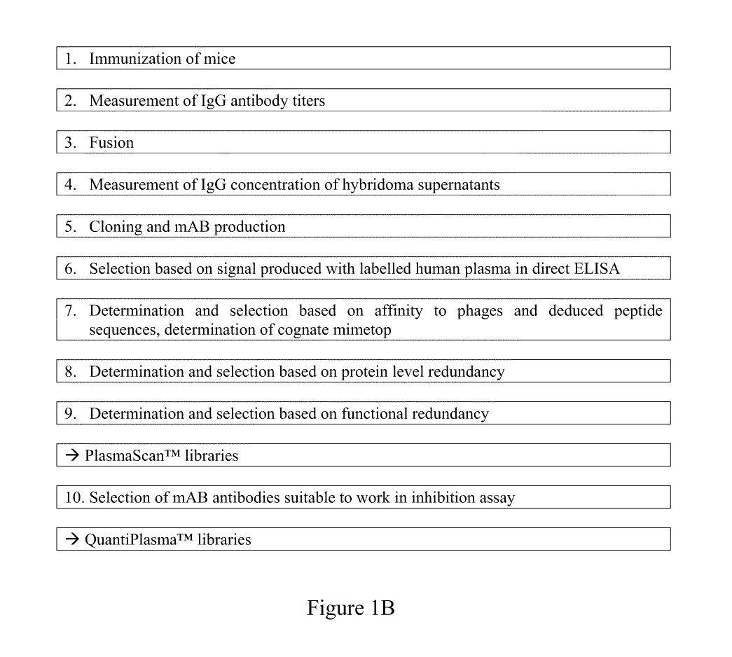

The present invention relates to an efficient mAb-based expression profiling technology platform (FIG. 1) suitable for global and accurate measurement of proteins, peptides and metabolites in complex mixtures. The platform is comprised of technologies that are coupled in a unique fashion to provide a novel platform technology for (i) the discovery of differentially displayed elements of complex protein, peptide and metabolite mixtures and (ii) the development of robust monoclonal antibodies (mAb) based assays that detect the differentially expressed elements.

As discussed above, a first object of this invention relates to a method of global protein peptide and/or metabolite expression profiling from a complex analyte sample, comprising of the following steps:
a) Enrichment of the complex analyte sample;
b) Immunization of a non-human mammalian subject with either (i) the enriched complex analyte sample or an aliquot or dilution thereof (shotgun immunization) or (ii) or with a limited analyte library prepared from the enriched complex analyte sample (Limited Immunization); or (iii) with the analyte conjugated to a carrier prior to immunization (Conjugated immunization) and
c) Generation of a panel of monoclonal antibodies, derivatives thereof, corresponding hybridomas and/or producing cells, and optionally, analysing the expression profile of said antibodies and/or identifying any antigen bound by antibodies from the panel.

The non human vertebrate may be any non human mammal, such as but not limited to a rodent, a rabbit, or a chicken.

A further particular object of this invention is a method of monoclonal antibody mediated expression profiling by the generation of many mono or oligoclonal hybridomas, mono or oligoclonal hybridoma supernatants, monoclonal antibodies, a monoclonal antibody panel from nom human vertebrates immunized as disclosed above and screening said monoclonal antibody panel for differential reactivity for at least two different samples of complex analytes. The process preferably involves the following steps:
Generation of a panel of monoclonal antibodies or derivatives thereof, wherein said panel comprises a plurality of containers comprising annotated monoclonal antibodies, corresponding to monoclonal or oligoclonal antibody producing hybridomas, specific for distinct analyte elements, e.g. human blood antigens. Moreover, wherein said panel comprises antibodies, or derivatives thereof, those e.g., which bind to low abundant antigens from diseased and from healthy human subjects.

A further particular object of the invention resides in a method of identifying human blood antigens comprising the following steps:

a) providing a sample of human blood and depleting from said sample abundant proteins represented in the plasma at a concentration level higher than 1 mg/ml while retaining low abundant proteins present in normal human blood, said depleted proteins comprising at least one protein selected from the group consisting of human serum albumin, IgG, IgA, transferrin, haptoglobin, and anti-trypsin; wherein the depleted sample comprises less than 5% of total proteins present in normal human blood;
b) immunizing a rodent using as an immunogen the depleted sample of a), or an aliquot or dilution thereof, wherein said immunization comprises from 3 to 6 sequential injections of less than 15 μg of said immunogen each;
c) generating, from said immunized rodent, a panel of hybridomas which produce a panel of monoclonal antibodies that bind antigens of said sample, wherein said antibodies in said panel exhibit less that 5% mimotope sequence redundancy and wherein each of said hybridomas produces at least 20 ng/ml monoclonal antibody;
d) purifying antigens from the blood sample by affinity enrichment using monoclonal antibodies generated in c); and
e) determining the identity of said human blood antigens.

A substantial and unexpected advantage of the method as presently disclosed resides in the wide diversity of the repertoire of antibodies generated.

As disclosed in the examples, the invention provides antibody panels or libraries with minimal redundancy and strong affinity, directed against valuable low abundance human antigens. In particular, the method of the invention provides monoclonal antibody mixtures having less than 10%, even more preferably less than 8%, further more preferably less than about 5% mimotope sequence redundancy. Within the context of this invention, the term mimotope sequence redundancy between antibodies designates the ability of antibodies in the panel to bind mimotope sequences having as few as 50% sequence identity. A panel of antibodies having less than 5% mimotope sequence redundancy thus designates a panel of antibody which contains less than 5% antibodies having the ability to bind a mimotope sequence having 50% sequence identity.

The inventors analyzed sequence redundancy obtained via the use of pairwise linear string matching to compare mimotope sequences. Experiments performed using 276 monoclonal antibodies obtained following the method as presently claimed show that only 12 pairs had more than 50% redundancy. None of the antibodies obtained recognizes the exact same set of peptides. These results therefore demonstrate that the method leads to a wide repertoire of antibodies.

These results are particularly surprising considering the apparent opposition of high affinity vs high diversity of antibody generation. Indeed, after first exposure to an antigen, it is known that the immune system will first produce a large repertoire of antibodies with weak affinity, essentially of the IgM type. With repeated exposures to the same antigen, the immune system will produce antibodies of successively greater affinities. A secondary response, termed affinity maturation, can elicit antibodies with several log fold greater affinity than in a primary response. The main biological mechanisms of affinity maturation are somatic hypermutation mutation and clonal selection. Somatic mutation rate is significantly higher in maturing B cells that react first to a foreign antigen. The mutation rate of variable regions segments of immunoglobulin heavy and light chains is a million fold higher than in the DNA of other genomic regions, this involves DNA repair mechanisms that are suppressed in early B cells.

Once antigen is present over longer than a critical time a small population of clonal B cells, a few clones that produce high affinity antibodies against the antigen will receive growth and survival advantages, this is the clonal selection process. These clones will contribute dominantly to the secreted IgG that circulates in the blood and that reacts with the particular antigen.

Mechanistic studies (reviewed in Rajewsky K et al. Science 238, p. 1088, 1987) using genetically manipulated mice suggest that somatic mutation terminates at the isotype switch (when early IgM precursors switch their V region segments to other isotype, mainly IgG contstant regions). Clonal selection operates after this.

If the immunogen is complex, like the human plasma proteome, the process should be even more amplified and the immune system should first activate many B cell precursor clones as the number of immunogenic epitopes is very high (e.g., in the range of 10 000). First, low affinity, surface 1g of IgM or IgD serotype, will react with the injected immunogen. Subsequently, as the result of successful activation, the triggered clones will switch isotype and will produce Ig in secreted form: generally IgG and most often IgG1. It is expected that the further exposure to the immunogen will induce affinity maturation and that the initial larger responding clonal repertoire will substantially shrink.

Single injection of an antigen leads to IgM as tested 2-4 weeks after immunization. It would be expected that recovering large B cell repertoire would be possible immediately after this event, thus about 2-4 weeks after a single injection of the antigen, but such a repertoire would be expected to contain mainly IgMs, which are not the most useful mABs for biomarkers and diagnostics as most of them have too low affinity.

Unexpectedly, the inventors have found that a large repertoire of high affinity IgG antibodies can be recovered in the IgG pool of mice which have been immunized according to the invention. One would expect that at this point after the 3^{rd} immunization due to clonal selection, the mAB repertoire would be limited. In fact, among tested mice, all of them except for one produced a non redundant repertoire at the level of epitopes and minimally redundant repertoire at the level of tested proteins.

Furthermore, in addition to the broad repertoire, the invention allows the generation of high producing hybridomas. In particular, hybridomas can be selected which produce at least 20 ng/ml of mAb, preferably at least 30, 40, or 50 ng/ml. As shown in the figures, hybridomas producing above 100 ng/ml are also produced.

Moreover, kinetics and the magnitude of the binding, as measured by surface plasmon resonance technology (Biacore), is consistent with the generation of good affinity immunoglobulins.

The invention thus allows the generation of a large repertoire of good affinity antibodies against valuable human plasma antigens.

In a preferred embodiment of the invention, the immunization comprises 3 injections of the immunogen, with an adjuvant, at approximately 2 weeks interval each. The adjuvant may be selected from immune-stimulating compounds or treatments, including cytokines, immune enhacers, etc. Specific examples include Freund's complete adjuvant, aluminium salts (e.g., AlOH), etc.

In a particular embodiment of the method, the immunization scheme further comprises a boost injection of the immunogen, with no adjuvant, prior to hybridoma generation.

A preferred administration protocol comprises the administration of less than about 15 μg immunogen per injection, even more preferably of about 10 μg of immunogen per injection.

Also, while different routes may be contemplated, the injections are preferably performed by subcutaneous, iv or intraperitoneal routes.

A most preferred immunization comprises 3 injections of about 10-15 μg immunogen each, in the presence of an adjuvant, at about 2 weeks intervals, followed by one or two boost injections of between 10-15 μg immunogen, in the absence of adjuvant, shortly (i.e., between 1-5 days, most preferably between 2-4 days) before step c).

The complex analyte preferably comprises of at least two clinical samples. The clinical samples may represent at least two disease conditions or at least one drug-responding group and one non-responding group or disease susceptible and non-susceptible individuals or diseased and apparently healthy subjects such as but not limited to cancer patients before and after tumor resection or cancer patients with and without recurrence of primary cancer, or cancer patients with and without metastasis.

According to specific embodiments, the clinical sample is selected from human serum or plasma, human urine, human sputum, human brochoalveolar fluid, human biopsy material, human tissue section, human faces and human exudates. The blood sample is typically selected from whole blood, plasma, serum, dilutions or derivatives thereof; or a combination thereof. Derivatives indicates the sample may be treated (e.g., heated, concentrated, frozen, mixed, etc). Also, in a particular embodiment, the sample is treated to separate analytes sharing particular physicochemical characteristic(s).

After protein synthesis co- and post-translational modification of amino acids extend the range of functions of the protein by attaching other biochemical functional groups such as acetate, phosphate, various lipids and carbohydrates, changing in this way the chemical nature of an amino acid or by making structural changes, like the formation of disulfide bridges. Glycosylation is one of the most frequent of such modifications and can be either N-linked (via asparagines residues) or O-linked (via threonine or serin residues) type. Glycosylation in most instances is site specific and any given site exhibits microheterogeneity in its carbohydrate structures. There has been rapid progress in the characterization and understanding of the biological roles of the carbohydrate moieties on glycoproteins. This is particularly true in the efforts to elucidate the role of oligosaccharide microheterogeneity and site occupancy in biological recognition, in receptor—ligand or cell—cell interactions, in the modulation of immunogenicity and protein folding as well as in the regulation of protein bioactivity. Glycan characterization is also of high importance in the biopharmaceutical industry as it provides indispensable information on immunogenicity and efficacy. Analysis of the glycosylation profile of production batches is needed to ensure consistent bioactivity, and rapid, robust and high-resolution bioanalytical techniques can be used, including electrophoresis, liquid chromatography, mass spectrometry and nuclear magnetic resonance spectroscopy.

In a specific embodiment, the method comprises a step of treating the sample, prior to immunization, to separate antigens modified or not modified through co- and post-translational modification. For example, the sample may be treated prior to step a) or b), to eliminate either glycosylated or unglycosylated proteins.

In a specific embodiment, the monoclonal antibody panel is screened via ELISA assay.

In a further specific embodiment, the monoclonal antibody panel is immobilized to a surface, such as a solid surface, in particular but not limited to glass, silicon, plastic, membrane (and is screened e.g., as microarray). Alternatively, the monoclonal antibody panel may be immobilized to any gel for screening. The monoclonal antibody panel may be screened in multiplex antibody arrays comprising fluorescent antibody conjugated beads. In a particular embodiment, the monoclonal antibody panel is screened via chemiluminescent assay.

The density of the array may be variable, and adjusted by the skilled artisan. Typical densities include a density ranging from 10-1,000/cm² to about 1,000-1,000,000/cm².

1. Complex Samples:

Mixture of proteins and small molecules, e.g., but not limited to: biological samples like: plasma, serum, urine, body fluids, cell lysates, tissue extracts of human and animal origin. Environmental samples; such as soil, water, cloud condensate, food processing intermediates and food products. Cosmetics and other healthcare products. Any complex mixture that contains immunogen metabolites and/or immunogen proteins, peptides. The complex sample could be a mix of individual complex analyte samples.

In order to enrich for differentially expressed elements of two or multiple complex samples to be compared; the samples will be enriched for the those elements that are of special interest (see below)

2. Enrichment by Partitioning

Some elements of complex samples are irrelevant for subsequent analysis, either because these do not carry information relative to the question that drives the analysis, and/or their abundance is so high that it interferes and jeopardizes the analysis process (e.g. albumin in human plasma samples). Affinity chromatography will be used to eliminate these elements. The partitioning process may be mediated by individual monoclonal antibodies, mixtures of monoclonal antibodies, polyclonal antiserum or ligands to which undesired elements will bind. Either the depleted fraction or the eluate of affinity chromatography process might be used for further steps.

A specific example: Immunosorbent chromatography, e.g.: columns from GenWay, Inc or Agilent Inc. are used to remove the most abundant serum and plasma proteins. Alternatively, anti-human serum could be used to remove elements of the complex human mixture that are both relatively highly abundant, and present or enriched only in healthy individuals. Moreover, polyclonal antisera prepared to specific mixtures or proteins or metabolites, metabolite classes could be applied either to enrich or to deplete these from the complex analyte mixture.

In a specific embodiment, the enrichment is carried out by treating the sample to partition. Preferably, the treating comprises separation technology; affinity enrichment e.g., using antibodies; organic ligand affinity chromatography; ion exchange chromatography; hydrophobic interaction chromatography; hydrophilic interaction chromatography; electrophoresis; size exclusion chromatography; chromatofocusing; isoelectrofocusing or a combination thereof.

3. Analyte Library Generation

### (Multidimensional Separations Based on Physical, Chemical and Biochemical Characteristics, Differential Display)

In order to support downstream analyte identification (ID) processes, complex mixtures are separated into specific classes via a suitable multidimensional and hierarchic separation process that is based on physical, chemical and biochemical characteristics of the complex mixture. The result of this step is a hierarchic set of pools; within the pool of complex mixtures the individual elements share at least one common characteristics. Process proximal pools differ in complexity from process distal pools and share fewer characteristics. Process ultimate pools might contain only a single type/class of element that is apparently homogeneous and contains no or only trace amount of less related contaminating elements. These ultimate pools if loaded to identification process (e.g. mass spectrometry based protein ID) will provide a single ID or a very likely one.

Screening of pools with mAb-s (ID screen) provides information on the shared physical, chemical and biochemical characteristics.

Analyte library is not necessarily the same as the one that is being profiled.

Differential display analysis of labeled samples from the separated fractions: Comparison of analyte libraries allows the identification of apparent differences at the level of pools in complexity levels and relative representation of individual elements. These pools being differentially displayed, could be applied preferentially for the immunization process (Limited immunization).

For limited immunization, an analyte library is generated, typically by separating analytes having common physicochemical or biological properties. Typically, all elements recovered and placed to individual containers.

4. 4.A. Shot-Gun Immunization

Immunization with complex protein sample: Either the enriched fraction or the complex protein mixture is used to immunize mice. Immunization is done by the use of well established technologies.

4.B. Limited immunization

Immunization with analyte pools. To increase the chances of obtaining monoclonal hybridomas reactive with all immunogen elements, lower complexity analyte pools are used for immunization. These pools could contain proteins, peptides or metabolites that share at least one important physical chemical or biochemical characteristics. As described in 3A, proteins are used for immunization directly, while peptides, and metabolites are used after derivatization to adjuvant immunogens.

In a specific embodiment of limited immunization, non human mammals are immunized with a one or more elements of the analyte library.

In particular embodiments, more than two elements of the analyte library share at least one physicochemical characteristic and/or at least one biochemical characteristic and/or at least one immunochemical property and/or at least one affinity binding capacity and/or are homologous in their peptide sequence.

4.C. Conjugated immunization

Immunization with complex peptide mixtures or complex metabolites, or individual peptide or metabolites: This step involves derivatization of an adjuvant immunogen carrier protein or artificial adjuvant immunogenic polymer in fashion that permits conjugation of peptides or metabolites. Metabolites and peptides are coupled to the adjuvant immunogen via their reactive groups in separate conjugation processes, e.g.: one process for OH esters, another for NH2 groups etc. Finally derivatized adjuvant immunogens are mixed and the mixture is used to immunize mice

5. Monoclonal Antibody (mAb) Mediated Expression Profiling of Individual Samples

High sensitivity micro-ELISA assays are designed that use the monoclonal hybridoma supernatant and labeled complex tracers derived from the complex sample or its pools. Thousands of mAb containing hybridoma supernatants are tested in a screen to identify those that discriminate individual classes of analyte samples (e.g. derived from disease vs. healthy individuals, or treated vs. non treated groups, etc.).

6. Monoclonal Antibody Panel Generation

After rigorous statistical calculations a panel of mAb containing hybridomas are selected. Large scale mAb generation could be initiated for each selected hybridoma at this step. The panel is subjected to downstream steps in order to identify “ID” each immunogen antigen that reacts with an individual mAb in panel.

The antibody derivatives may be an antibody fragment, preferably selected from Fab, Fab', CDR, and single chain antibodies (ScFv). The antibody derivative is preferably a human or humanized antibody or fragment thereof. Such derivatives may be produced by any method known per se in the art.

One way to produce humanized antibodies is to isolate the cDNA of a particular mouse monoclonal antibody, sequence the cDNA region coding for the peptide region that binds to the antigen. One can directly sequence this region via peptides sequencing technologies. In the next step the region is cloned into the similar region of a human antibody cDNA and expressed. Particular care should be paid to engineer the regions of glycosilation to ensure that these are human like. The step above can be applied to the heavy chain or to the light chain or to both. An alternative way is to produce monoclonal antibodies from transgenic mice that carry a part of or the entire human antibody gene sets, but may not have mouse antibody genes. These mice produce human antibodies and may not produce mouse antibodies

7. ID Screen

This step (optional) involves the screening of analyte library pools in a hierarchic and economic manner to identify the pool that contains the antigen recognized by the monoclonal antibody, or the monoclonal antibody containing hybridoma supernatant. If necessary, affinity enrichment and targeted screening steps are deployed to identify the antigen.

8. Affinity Enrichment

Affinity enrichment that can be but not limited to column or microbead based processes. The relevant mAb's generated during steps 1-5 and screened positive in Step 6 are immobilized to appropriate stationary phase material or micro-bead substrate and used as bait for antigen purification. This process can be repeated as many times as necessary to collect the required amount of material for downstream processing.

9. Separation and Fractionation

The separation and fractionation of the enriched eluent from Step 8 can be accomplished but not limited to liquid chromatography (LC), capillary electrophoresis (CE), capillary electrochromatography (CEC), microchip based analytical methods or other separation technologies. The collected fractions or split eluent stream is being interrogated in Step 10 for activity in a mAb mediated screen (targeted screening)

10. Targeted screening
(i) (10A) One part of the split flow is used for screening the fractions of Step 8 for antibody reactivity with the appropriate mAb, and collected for ID analysis in step 10B.
(ii) (Loop to Step 8) Break the mAb/AG complex and reprocess the mAb in Step 8.
(iii)(10B) Mass spectrometry (MS and MSⁿ) based identification using but not limited to ESI or MALDI ionization methods. In case of proteins, digestion, separation and MSⁿ. In case of metabolites, separation and MSⁿ.

In a particular embodiment, the method of ID screening comprises a step of identifying antigens recognized by antibodies or derivatives thereof within said complex sample and/or analyte library where identification comprises the steps below:
Reacting selected monoclonal antibody with complex analyte or element of analyte library, or with a biological sample
Eluting cognate antigen
Identification of cognate antigen via hyphenated chromatography and/or electric field mediated separation system—mass spectrometry or direct peptide sequencing methods.

The identification of said antigens typically comprise contacting an antibody or derivative thereof with a biological sample and determining the identity of an antigen specifically bound to said antibody or derivative thereof. Identification of the cognate antigen may be preceded by screening the entire or part of the analyte library in order to identify the source of material for the cognate antigen ID. Alternatively, or in addition, identification of the cognate antigen may be preceded by affinity enrichment of the antigen and/or by partitioning, including but not limited to separation and fractionation.

In a particular embodiment, the process is an automated platform, and/or involves one or more microfluidic or micro total analysis system (μTAS) chip

### Production of a Panel (or Library) of Antibodies Specific for Human Blood Antigens

A particular object of this invention resides in a method for producing a library or panel of monoclonal antibodies, or derivatives thereof, specific for human blood antigens, the method comprising the steps of:
a) providing at least one biological sample comprising human blood antigens;
b) treating said sample under conditions allowing depletion of abundant proteins while retaining low abundant proteins present in normal human blood;
c) using said treated sample or a portion thereof as an immunogen to immunize a non-human mammalian; and
d) preparing monoclonal antibodies, or derivatives thereof, specific for human blood antigens, from said immunized non-human mammalian, thereby obtaining said panel (or library).

According to a preferred embodiment, the method further comprises a step of profiling antibodies, or derivatives thereof, within the panel against one or several control or diseased samples, to obtain an annotated panel of monoclonal antibodies, or derivatives thereof. The profiling step typically comprises determining whether the antibody or derivative thereof specifically binds an antigen contained in a blood sample from a control or diseased human subject.

In a particular embodiment, the profiling step comprises determining whether the antibody or derivative thereof binds an antigen present in at least one control sample and two diseased samples.

The method of this invention preferably further comprises a step of identifying antigens recognized by antibodies or derivatives thereof within said panel. The identification of said antigens typically comprises contacting an antibody or derivative thereof from the panel with a biological sample and determining the identity of an antigen specifically bound to said antibody or derivative thereof.

As discussed above, the antibody derivative is e.g., an antibody fragment, preferably selected from Fab, Fab', CDR and single chain antibodies (ScFv). The antibody derivative is preferably a human or humanized antibody or a fragment thereof.

A further particular embodiment of the invention resides in a method of making antibodies that bind human blood antigens, comprising the following steps:

a) providing a sample of human blood and depleting from said sample abundant proteins represented in the plasma at a concentration level higher than 1 mg/ml while retaining low abundant proteins present in normal human blood, said depleted proteins comprising at least one protein selected from the group consisting of human serum albumin, IgG, IgA, transferrin, haptoglobin, and anti-trypsin; wherein the depleted sample comprises less than 5% of total proteins present in normal human blood;
b) immunizing a rodent using as an immunogen the depleted sample of a), or an aliquot or dilution thereof, wherein said immunization comprises from 3 to 6 sequential injections of less than 15 μg of said immunogen;
c) generating, from said immunized rodent, a panel of hybridomas which produce a panel of monoclonal antibodies that bind antigens of said sample, wherein said antibodies in said panel exhibit less that 5% mimotope sequence redundancy and wherein each of said hybridomas produces at least 20 ng/ml monoclonal antibody;
d) optionally sequencing one, several, or all of said monoclonal antibodies or the coding nucleic acid;
e) optionally producing one, several or all of said antibodies, or derivatives thereof having the same antigen specificity, by recombinant technology; and f) collecting antibodies of step c), d) or e).

The biological sample comprising human blood antigens typically is or derives from a human plasma sample, a human serum sample or a human blood sample. The biological sample is preferably derived from a healthy human subject.

In a particular embodiment of the method, the panel comprises monoclonal antibodies or derivatives thereof produced from biological samples from different human subjects. The biological samples may all derive from several healthy subjects, or from several healthy and diseased subjects.

In step b) above, the sample is typically contacted with an affinity column that removes from 2 to 22 most abundant human proteins. The depleted sample preferably comprises between about 5 to 10% of total human serum proteins.

In step c) above, the whole treated sample, in aliquots, may be used as an immunogen, or different classes of antigens present in the sample are separated, and separate immunizations are performed with each of said classes.

The panel can comprise a plurality of monoclonal antibodies, producing hybridomas and/or derivatives thereof, which are arranged in separate containers. In this respect, a particular object of this invention also resides in a panel (or library) of monoclonal antibodies, or derivatives thereof, wherein said panel comprises a plurality of containers comprising annotated monoclonal antibodies, or derivatives thereof, or corresponding producing hybridomas, specific for distinct human blood antigens, wherein said panel comprises antibodies, or derivatives thereof, that bind low abundant antigens from diseased and from healthy human subjects.

The invention also concerns a product comprising, immobilized on a support, preferably in an ordered manner, a plurality of monoclonal antibodies, or derivatives thereof, specific for distinct human blood antigens, wherein said product comprises antibodies, or derivatives thereof, that bind low abundant antigens from diseased and from healthy human subjects. As discussed above, the support may be a solid or semi-solid material, such as a membrane, glass, plastic, ceramic or metal support having a surface, or a gel.

Such a panel of mAbsor product may be used to identify markers, therapeutic antibodies, to design diagnostic kits, etc. In this respect, a particular object of this invention also concerns a method for identifying antibodies that bind a selected target, the method comprising contacting said target with all or a portion of a panel of monoclonal antibodies, or derivatives thereof, as defined above or obtainable by a method as defined above, or with a product as defined above, under conditions allowing an antigen-antibody reaction to occur, and identifying one or several monoclonal antibodies, or derivatives thereof, from said mAb panel, that bind said target.

Libraries can be used for human plasma profiling in direct ELISA experiments that use immobilized mAB and labelled plasma (either depleted or non processed). This setup can be applied in high throughput ELISA setup but also on printed microarrays and other multiplex platforms (e.g. microrray experiments) and is termed QuantiPlasma™.

The invention also relates to a method for identifying antibodies that are specific for a particular condition or disease, the method comprising contacting a biological sample from a mammalian having said condition or disease with all or a portion of a panel of monoclonal antibodies, or derivatives thereof, as defined above or obtainable by a method as defined above, or with a product as defined above, under conditions allowing an antigen-antibody reaction to occur, and identifying one or several monoclonal antibodies, or derivatives thereof, from said library, that form antibody-antigen complexes with said sample.

The invention further relates to a method for identifying one or several mammalian antigens specific to a condition or disease, the method comprising contacting a biological sample from a mammalian having said condition or disease with all or a portion of a panel of monoclonal antibodies, or derivatives thereof, as defined above or obtainable by a method as defined above, or with a product as defined above, under conditions allowing an antigen-antibody reaction to occur, identifying one or several monoclonal antibodies, or derivatives thereof, from said panel, that form antibody-antigen complexes with said sample and, identifying antigens engaged into said complexes.

Further aspects and advantages of the present invention will be disclosed in the following examples, which should be considered as illustrative and not limiting the scope of this application.

### EXAMPLES

### Example 1

### Generation of a Panel of Antibodies Against Human Blood Proteins

### 1.1—Enrichment by Partitioning

A complex analyte sample (human plasma) is treated to partition. Highly abundant proteins are separated here from medium and low abundant ones via affinity chromatography using a commercial chromatography system with a multiaffinity removal column (Agilent). Highly abundant proteins are those that are represent in the plasma at a concentration level that is higher than 1 mg/ml. The experiment is performed as described in the Agilent Technologies manual. In the example, the enriched sample contains minimal, trace, or not detectable concentrations of the following proteins: human serum albumin, IgA, haptoglobin, anti-trypsin, IgG, transferrin

To test the efficiency of enrichment, specific protein analytes were coated onto plastic plates and specific mAbs were used to detect the bound analyte species (e.g. Apolipoprotien A1, complement factor C3, IgA). The amount of specific mAb bound is in direct correlation with the analytes species quantity bound to the plastic surface, mAb binding was visualized by horse radish peroxidase coupled rabbit anti-mouse Ig. Standard curves were used to calculate relative abundance level, which is expressed in fractions (%) of total protein content of the analyte. Results show that only traces of IgA is detectable, while other analytes species are enriched.

TABLE 1
Relative abundance level of various protein analyte
species before and after the treatment.

| | Before | After depletion |
|---|---|---|
| | Depletion (%) | (%) |
| ApoA1 | 1.1 | 16.5 |
| C3 | 0.5 | 20 |
| IgA | 1.25 | 0.32 |

### 1.2—Analyte Library Generation

Analyte libraries are generated from complex analyte mixtures that may contain proteins, peptides and/or metabolites at the same time. Multidimensional separation technology is applied to partition all elements or specific classes of elements, e.g. proteins from all metabolites. Moreover, complex separation processes can also be applied e.g. those that retain the proteins in their antigenic conformations, yet allow separation of classes or individual types of proteins. Separation technologies that use caotripic agents e.g., detergents, e.g. SDS are usually irreversibly denaturing, prevent the analyte to react with antibodies that exclusively recognize the natural conformation. High concentration of organic solvents and the process of binding and elution from separation surfaces are denaturing as well. Thus a carefully selected process is applied that conserves antigenic determinants. An initial step could be affinity chromatography with polyclonal antibody directed against components of the complex analyte.

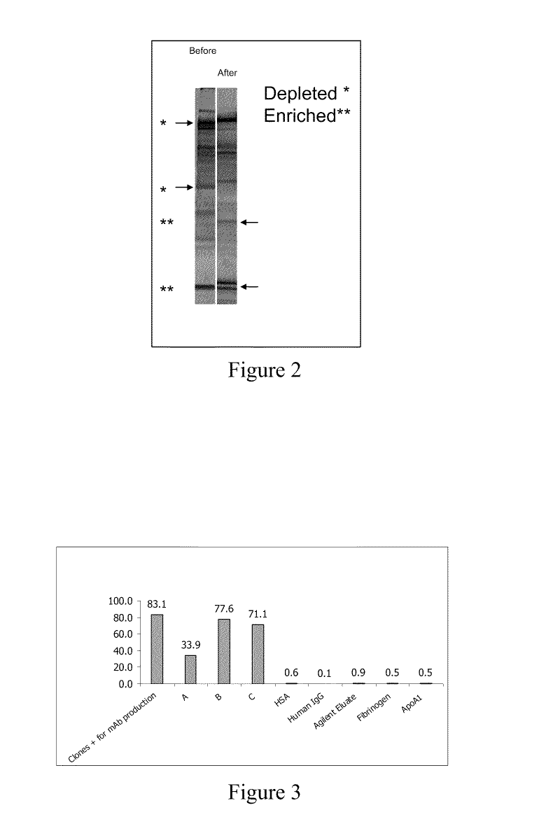

To determine the efficiency and progress of analyte library preparation, SDS PAGE electrophoresis separation was done on samples that have undergone affinity chromatography separation mediated by a polyclonal antibody directed to the human serum. The separation step clearly enriches some elements while some others are virtually eliminated. (FIG. 2).

### 1.3—Shotgun Immunization and Antibody Generation

Complex enriched or enriched and treated analyte mix directly (protein samples) or after conjugation en-mass to immunoadjuvant carriers (peptide and metabolite samples) are injected into mice or other species that develops a clonable antibody repertoire. In the example, treated complex analyte mix, human plasma, was injected into Balbc female mice in the presence of complete Freund adjuvant first, then bi-weekly in the presence of incomplete adjuvant. Injections were done into the footpad and s.c. at multiple places. The last injection was done i.v. without adjuvant. Three days after the last injection spleen cells were fused to Sp2Ag0 mouse hybridoma partner cells in the presence of 50% Polyethylene glycol. Fused cells were cultured in 96 well plates in the presence of selection medium. One thousand one hundred eighty five hybridoma supernatants from this antibody panel were screened in ELISA assays. As shown on FIG. 3. 83.1% of the supernatants produced antibodies. Three different plasma preparations have been tested. It is evident, that 77.6 percent of the clones react with plasma proteins in sample A, only 33.9 in sample B, while 71.1% react with sample C, 14.5% of clones positive with B, give higher signal with C than B while 75.1% of clones positive with sample A give higher signal with B than A. The majority of the mAB panel elements thus detect representational differences in protein level and together this is suitable for protein expression profiling. Utility of a plasma proteome specific mAb panel or library is dependent on the level of redundancy, e.g. the number of antibody clones directed against the most abundant proteins in the plasma. We have tested some of those that are removed from the complex analyte by the analyte treatment method described in example-I. Results are shown for serum albumin, IgG, fibrinogen and apolipoprotein A1 and the eluate of the Agilent depletion column (FIG. 3). Clones specific for these abundant proteins are represented at <1% frequency.

### Example 2

### Biomarker Determination by Affinity Enrichment, Separation Fractionation and ID Screening

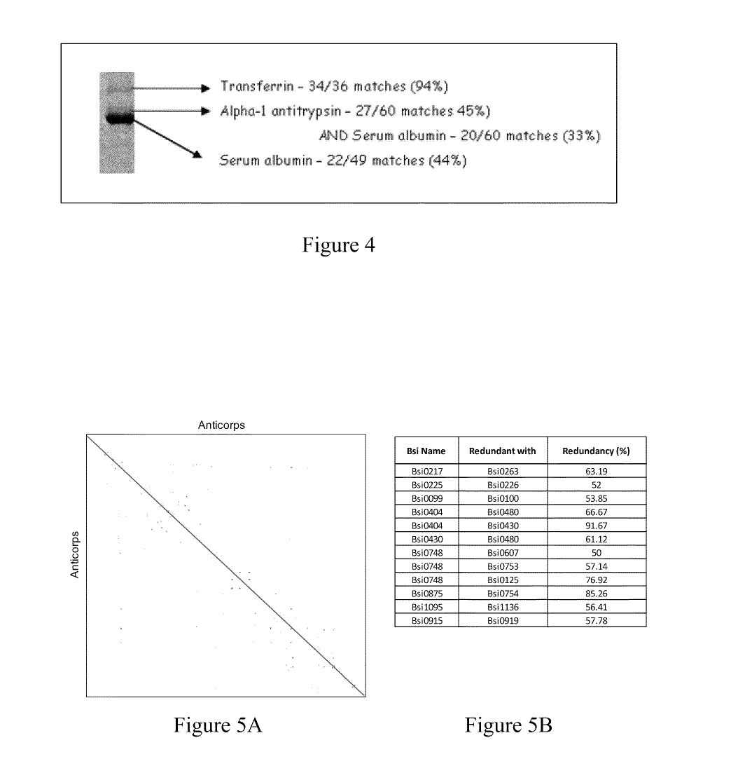

One possible regimen for protein ID is affinity purification followed by SDS gel electrophoresis and mass spectrometry (MS) on material derived from gel slices containing a single stainable band. In FIG. 4 we show that apparent purity (single band one gel slice) is sufficient criteria for good quality protein ID. In the complex analyte sample we applied onto SDS PAGE electrophoresis multiple proteins were present, still bands cut out from the gel provided single proteins and high quality ID, as analyzed by MALDI-TOF MS technology. As described below: Gel bands were rinsed with an ammonium bicarbonate buffer/acetonitrile 1:1 mixture in order to eliminate the gel stain (CBB) and SDS. The proteins were reduced by DTT, the free sulfhydrils were derivatized with iodoacetamide. Then the proteins were incubated with side chain protected porcine trypsin (Promega) for 4 hrs at 37° C. The resulting peptides were extracted and zip-tip purified. The unfractionated digests were subjected to MALDI-TOF MS analysis using 2,5-dihydroxy-benzoic acid (DHB) as matrix. An MS-Fit (http://prospector.ucsf.edu) database search was performed with the masses detected against the NCBI nonredundant protein database NCBInr.2005.01.06. During the search no species restriction was applied. The identity of the proteins was verified by post source decay (PSD) analysis of a selected peptide. The protein MWs and pIs obtained represented the full length sequences as listed in the database-that do not necessarily reflect the size of the expressed, especially the processed, mature, and active proteins.

### Example 3

### Generation of a Panel of Monoclonal Antibodies Against Human COPD Blood Biomarkers

For immunization and hybridoma generations, female mice (8-12 wk old) were immunized with 10 μg combined and affinity purified COPD plasma using complete (first immunization) and incomplete Freund's adjuvant (subsequent immunizations) or aluminum hydroxide gel (both from Sigma—Aldrich, St. Louis, Mo., USA). Immunogen was delivered by subcutaneous injections (hind footpads, dorsal neck region and dorsal area of the caudal proximity of the tail) in 2 wk intervals, three times. To relieve pain, major analgesics were used as needed. Finally, i.v. and intraperitoneal injections were done 3 days prior fusion without any adjuvant.

Spleen cells were prepared by gentle teasing the tissue between sterile frosted microscopic slides (Sigma—Aldrich) and hypotonic shock (15 s distilled water treatment followed by three washing steps in PBS) to remove red blood cells. Unless stated otherwise, all tissue culture reagents were purchased from Invitrogen (Carlsbad, Calif., USA).

Splenocytes were fused to Sp2/Ag0 myeloma cells (ATCC, Teddington, Middlesex, UK) with PEG (Sigma—Aldrich) as recommended. Hybridoma supernatants were generated in 96- and 24-well tissue cultures. Tissue culture wells positive in high throughput screening procedures were selected for cloning.

Hybridomas were cloned in selective media (Hypoxantin, Aminopterin, Thymidine, HAT) and adapted to regular media subsequently by gradual medium exchange. Antibody producing clones were selected by their reaction in the HTS ELISA assays.

Pooled plasma from the first five patients and five control subjects was used to prepare the complex immunogen. First, the six most abundant plasma proteins were removed from the individual pools via affinity chromatography. This approach resulted in an approximately ten-fold overall enrichment of the lower abundant proteins. The flow-through from this column was subjected to a second affinity purification step using a column containing immobilized polyclonal antibody prepared against normal human serum. The flowthrough of this second column was collected and used for immunization. The depletion processes was monitored by SDS-PAGE and by LC-MS. Analysis of the second affinity chromatography product showed that the analyte population, including the pool from apparently healthy subjects has been enriched and disease-specific proteins were seen that were not detectable in the control sample.

The enriched plasma protein mixture from the control subjects and COPD patients were then injected to BALB/c mice as complex immunogen. Spleens from four mice (two of each: normal and COPD patient samples, respectively) were used for hybridoma generation via somatic cell fusion to SP2 μg0 cells and seeding to microwells under quasi-limiting conditions. A total number of 3500 hybridoma supernatants were generated and screened by ELISA assay. The first step HASA screening was based on hybridoma IgG capture and its tracer binding. Differential binding of 0.25% to COPD-tracer versus health-tracer was set as selection criteria. The first level screening produced 250 biomarker hits, which were tested by a competitive inhibition assay using individual subject plasma samples. In these assays, tracer binding was inhibited by plasma samples of individual subjects. This second screening step reduced the number of hit candidates to ten high quality biomarker leads. All ten individual biomarker leads showed statistically significant discrimination power with the nonparametric Mann-Whitney test.

This example thus discloses the identification and prevalidation of human COPD protein biomarkers in a single step. The global proteomics strategy delivers mAb's applicable for the identification of biomarker proteins relevant to various therapeutic conditions, which may serve as early diagnostics, to detect changes induced by treatment, recognize patient groups with higher response rate.

### Example 4

### Generation of a Panel of Monoclonal Antibodies Against Human Lung Cancer Blood Biomarkers

A library of monoclonal antibodies specific of human lung cancer plasma antigens was generated following method of the present invention. The library was then screened against pooled biotinylated lung cancer (LC) plasma and control plasma samples. Individual plasma sample screening validated the results (see BSI mAB 4 and ROC curve)

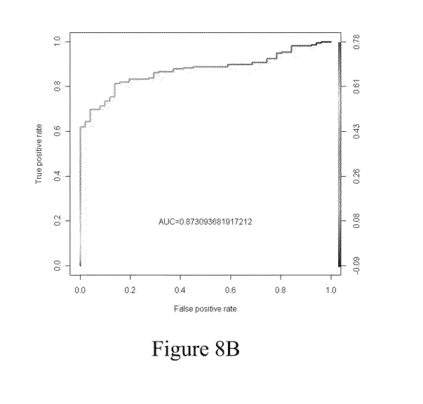

Reaction pattern of disease specific (based on pool screening) nascent and cloned biomarker mAB candidates were analyzed by pair wise comparison of 63 mAB ELISA results from 150 biotinylated plasma samples. The results show that the library contains lung-cancer specific antibodies which discriminate patients from healthy subjects. The results also show that a single antibody of the library already provides good discrimination between lung cancer and control subjects with >80% sensitivity and specificity, thereby further illustrating the efficiency of the present method (see FIG. 8). This antibody was validated on three independent cohorts of individual lung cancer and control plasma samples.

### Example 5

### Analysis of Antibody Repertoire and Isotype

Although, the number of immunogenic epitopes (human plasma proteome vs. Balb/c mouse host) may be over 10 fold higher than the number of individual proteins in the human plasma, thus >100,000 (estimate), the likelihood that our mAB generation process produces many mABs recognizing the same epitope (epitope level redundancy) and/or the same protein (protein level redundancy) was not negligible.

In order to address the issue of epitope level redundancy we tested our mABs in phage display experiments and in mAB antibody competition experiments. Protein level redundancy was tested on a set of 39 mABs in pairwise (immobilized vs. biotinylated) sandwich ELISA experiments.

The results obtained show the invention allows the production of a non redundant repertoire of antibodies against valuable, low abundance antigens in complex human blood samples. The diversity and redundancy was null at the level of epitopes.

In order to assess the epitope repertoire we deployed phage display experiments on 276 mAb antibodies derived from 10 different fusions, with identical immunization protocol and with the use of complex analyte immunogen.

We analyzed sequence redundancy obtained from the phage library via the use of pairwise linear string matching to compare sequences. The results show that, from all of the comparisons, only 12 pairs (i.e., about 4%) exhibit mimotope redundancy, i.e., had more than 50% mimotope sequence identity. 96% of the antibody pairs exhibit no redundancy. None of the pairs of mABs identified the exact same set of peptides. All comparison results are displayed graphically (FIG. 5A) and redundancy levels are shown for the top 12 comparisons (FIG. 5B).

Sandwich ELISA of 39% mABs in pairwise comparisons (immobilized vs. biotinylated) showed only three bi-directional reactions (black squares, <10%), while 15 mAB showed unidirectional reaction (grey squares) (FIG. 5C). These results thus demonstrate the very low level of redundancy of antibody libraries produced according to the invention.

We have analysed the isotype of the antibodies obtained by the invention. The distribution of IgG production shows that more than 40% of the hybridomas produce above 40 ng/ml of antibodies. In particular, 27% produced between 40-100 ng/ml, while 13% produced between 100-500 ng/ml.

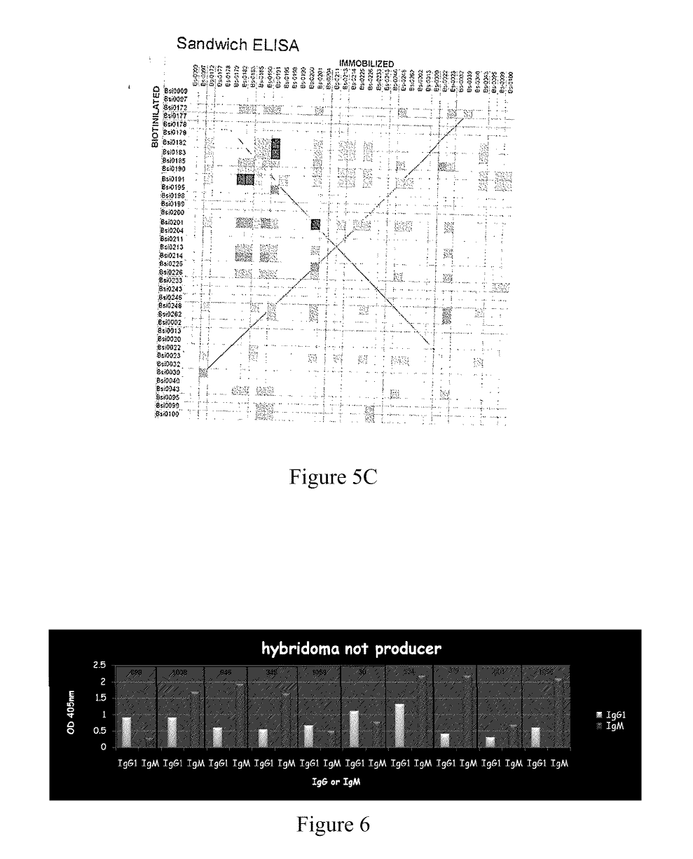

These results show the hybridomas producing high level of IgG antibodies are produced. It is striking to note that, in the “non” producer hybridoma wells, we do detect IgM (see FIG. 6), which indicates the immunization scheme and immunogen treatment of the invention allow stimulation of the immune system under conditions where the fusions are performed while the immune response is in “switch”. This may account for the unexpected and advantageous presence, in the antibody panel, of a wide diversity of high affinity IgG antibodies, because the clonal selection is not fully operational until the isotype switch is not completed.

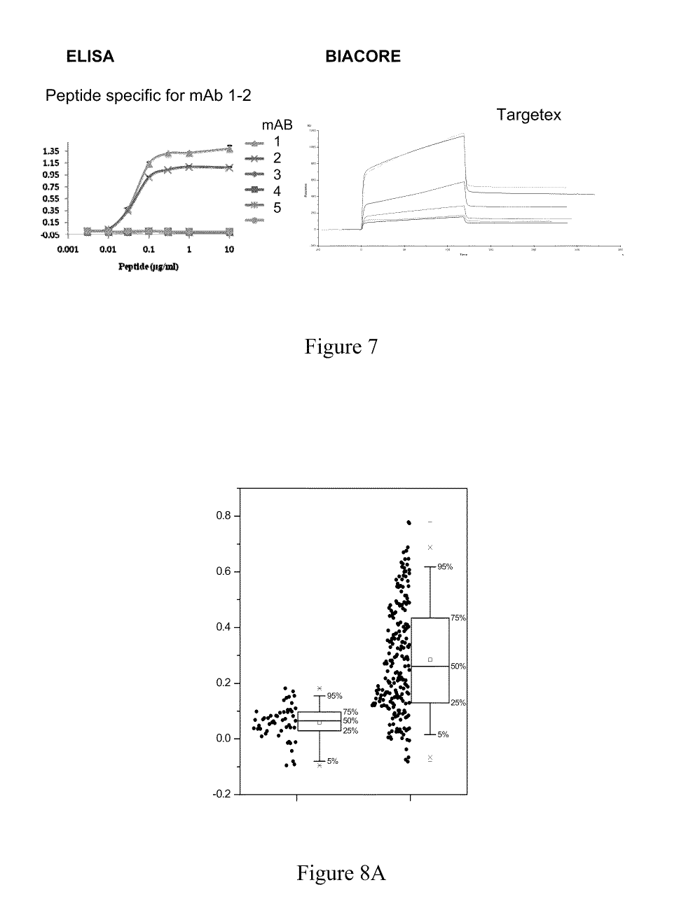

FIG. 7 shows the IgG antibody exhibit high affinity towards their cognate antigens. One peptide was selected for one of the redundant pair of antibodies (mAB 1 and mAB 2). Binding of this mAB was tested with five different mABs. The results show that the peptide only binds to the cognate mABs, namely mAB 1 and mAB2. (A). Kinetics and the magnitude of the binding as measured by surface plasmon resonance technology (Biacore) is consistent with good affinity.

1. A method of identifying human blood antigens comprising the following steps:
a) providing a sample of human blood and depleting from said sample abundant proteins represented in the plasma at a concentration level higher than 1 mg/ml while retaining low abundant proteins present in normal human blood, said depleted proteins comprising at least one protein selected from the group consisting of human serum albumin, IgG, IgA, transferrin, haptoglobin, and anti-trypsin; wherein the depleted sample comprises less than 5% of total proteins present in normal human blood;
b) immunizing a rodent using as an immunogen the depleted sample of a), or an aliquot or dilution thereof, wherein said immunization comprises from 3 to 6 sequential injections of less than 15 μg of said immunogen each;
c) generating, from said immunized rodent, a panel of hybridomas which produce a panel of monoclonal antibodies that bind antigens of said sample, wherein said antibodies in said panel exhibit less that 5% mimotope sequence redundancy and wherein each of said hybridomas produces at least 50 ng/ml monoclonal antibody;
d) purifying antigens from the blood sample by affinity enrichment using monoclonal antibodies generated in c); and
e) determining the identity of said human blood antigens.

2. The method of claim 1, wherein said immunization comprises 3 injections of the immunogen, with an adjuvant, at approximately 2 weeks interval each.

3. The method of claim 1, wherein said immunization further comprises a boost injection of the immunogen, with no adjuvant, prior to hybridoma generation.

4. The method of claim 1, wherein about 10 μg of immunogen is administered per injection.

5. The method of claim 1, wherein the injections are subcutaneous, iv or intraperitoneal injections.

6. The method of claim 1, wherein the hybridomas produce at least 100 ng/ml of monoclonal antibodies.

7. The method of claim 1, wherein said depletion of step a) comprises a separation or affinity enrichment treatment of the sample.

8. The method of claim 7, wherein said treatment of step a) comprises one or several treatments selected from organic ligand affinity chromatography, ion exchange chromatography, hydrophobic interaction chromatography, hydrophilic interaction chromatography, electrophoresis, size exclusion chromatography, chromatofocusing, or isoelectrofocusing, or a combination thereof.

9. The method of claim 1, wherein the blood sample is selected from whole blood, plasma, serum, dilutions or derivatives thereof or a combination thereof.

10. The method of claim 1, wherein the sample is treated prior to step a) or b) to eliminate either glycosylated or unglycosylated proteins.

11. A method of making antibodies that bind human blood antigens, comprising the following steps:
a) providing a sample of human blood and depleting from said sample abundant proteins represented in the plasma at a concentration level higher than 1 mg/ml while retaining low abundant proteins present in normal human blood, said depleted proteins comprising at least one protein selected from the group consisting of human serum albumin, IgG, IgA, transferrin, haptoglobin, and anti-trypsin; wherein the depleted sample comprises less than 5% of total proteins present in normal human blood;
b) immunizing a rodent using as an immunogen the depleted sample of a), or an aliquot or dilution thereof, wherein said immunization comprises from 3 to 6 sequential injections of less than 15 μg of said immunogen;
c) generating, from said immunized rodent, a panel of hybridomas which produce a panel of monoclonal antibodies that bind antigens of said sample, wherein said antibodies in said panel exhibit less that 5% mimotope sequence redundancy and wherein each of said hybridomas produces at least 20 ng/ml monoclonal antibody;
d) optionally sequencing one, several, or all of said monoclonal antibodies or the coding nucleic acid;
e) optionally producing one, several or all of said antibodies, or derivatives thereof having the same antigen specificity, by recombinant technology; and
f) collecting antibodies of step c), d) or e).

12. The method of claim 11, wherein said immunization comprises 3 injections of the immunogen, with an adjuvant, at approximately 2 weeks interval each.

13. The method of claim 11, wherein said immunization further comprises a boost injection of the immunogen, with no adjuvant, prior to hybridoma generation.

14. The method of claim 11, wherein about 10 μg of immunogen is administered per injection.

15. The method of claim 11, wherein the injections are subcutaneous, iv or intraperitoneal injections.

16. The method of claim 11, wherein the hybridomas produce at least 50 ng/ml of monoclonal antibodies.

17. The method of claim 11, wherein said depletion of step a) comprises a separation or affinity enrichment treatment of the sample.

18. The method of claim 17, wherein said treatment of step a) comprises one or several treatments selected from organic ligand affinity chromatography, ion exchange chromatography, hydrophobic interaction chromatography, hydrophilic interaction chromatography, electrophoresis, size exclusion chromatography, chromatofocusing, or isoelectrofocusing, or a combination thereof.

19. The method of claim 11, wherein the blood sample is selected from whole blood, plasma, serum, dilutions or derivatives thereof or a combination thereof.

20. The method of claim 11, further comprising a step of immobilizing the antibodies on a solid surface.

21. The method of claim 20, wherein the surface is selected from a glass surface, a silicon surface, a plastic or polymer surface (e.g., polystyrene), a paper surface, a membrane or a gel.

22. The method of claim 1, wherein steps a) to c) are repeated with one or several distinct blood samples.
